(19) United States
(12) Patent Application Publication
(10) Pub. No.: US 2006/0186584 A1
(43) Pub. Date: Aug. 24, 2006

(54) Method and apparatus for making a plastic pipe

(75) Inventor: Herbert Ulrich, Munster/Emsdetten (DE)

Correspondence Address: HENRY M FEIEREISEN, LLC, 350 FIFTH AVENUE, SUITE 4714, NEW YORK, NY, 10118, US

(73) Assignee: KRAUSS-MAFFEI KUNSTSTOFFTECHNIK GMBH, Munchen (DE)

(21) Appl. No.: 11/357,430

(22) Filed: Feb. 17, 2006

Related U.S. Application Data
(63) Continuation of application No. PCT/EP04/09077, filed on Aug. 13, 2004.

(30) Foreign Application Priority Data
Aug. 19, 2003 (DE) 103 37 964.9

(51) Int. Cl. B29C 53/00

(52) U.S. Cl. 264/564; 425/326.1

(57) ABSTRACT

In a method for producing plastic pipes, a melt strand is produced in an extruder and pushed through a pipe head for entry into a vacuum suction device, where the melted strand is formed into a pipe with a preliminary outer diameter. A selected sizing sleeve of a plurality of different sizing sleeves is placed in a sizing chamber for calibrating the outer diameter of the pipe in the sizing chamber to a desired dimension. Different sizing sleeves can be inserted into a sizing chamber. This can be achieved by a gripping device, whereby either the tubular melt strand is severed to allow axial insertion of the selected sizing sleeve over the pipe or into the sizing chamber, or the extrusion line is operated at creep speed, to allow the sizing sleeve to be placed around the pipe. The sizing sleeve is hereby split into segments for placement about the pipe, and the sizing sleeve is then inserted into the sizing chamber.

### CROSS-REFERENCES TO RELATED APPLICATIONS

This application is a continuation of prior filed copending PCT International application no. PCT/EP2004/009077, filed Aug. 13, 2004, which designated the United States and on which priority is claimed under 35 U.S.C. §120, and which claims the priority of German Patent Application, Serial No. 103 37 964.9, filed Aug. 19, 2003, pursuant to 35 U.S.C. 119(a)-(d), the contents of which are incorporated herein by reference.

### BACKGROUND OF THE INVENTION

The present invention relates, in general, to a method and apparatus for making plastic pipes.

Nothing in the following discussion of the state of the art is to be construed as an admission of prior art.

European Pat. No. EP 1 115 550 B1 discloses a method and apparatus for making plastic pipes, including an extrusion system that allows modification of the pipe diameter during continuous operation and includes a pipe head having a nozzle and mandrel which have a conical configuration. A change in the axial disposition of the mandrel allows adjustment of the wall thickness and diameter of the extruded melt strand. Disposed downstream of the pipe head is a bell-shaped vacuum suction device which accommodates measuring instruments for setting the vacuum in the suction device in dependence on the desired pipe diameter. The suction device is followed by a sizing chamber for precisely calibrating the outer diameter of the melt strand and thus the pipe which has already started to harden. The thus calibrated pipe is then advanced through a vacuum sizing tank which is equipped with an adjustable end gasket.

It would be desirable and advantageous to provide an improved method and apparatus to obviate prior art shortcomings and to simplify the overall construction and operation.

### SUMMARY OF THE INVENTION

According to one aspect of the present invention, a method of making a plastic pipe includes the steps of producing a melt strand in an extruder and pushing the melt strand through a pipe head, advancing the melt strand through a vacuum suction device for providing a pipe with a preliminary outer diameter, placing a selected sizing sleeve of a plurality of different sizing sleeves in a sizing chamber for calibrating the outer diameter of the pipe in the sizing chamber to a desired dimension, and cooling and hardening the pipe in a vacuum sizing tank.

According to another feature of the present invention, the placing step may include the steps of halting an advance of the pipe, and severing the pipe to provide access to the sizing chamber for placement of the selected one of the sizing sleeves.

According to another feature of the present invention, the placing step may include, as an alternative, the steps of advancing the pipe at creep speed, attaching the selected one of the sizing sleeves in surrounding relationship to the pipe, and advancing the pipe through the sizing chamber. In this way, exchange or replacement of sizing sleeves can be implemented without interruption of production and cutting of the extruded pipe. Each of the sizing sleeves is hereby split in segments to enable attachment to the slowly advancing pipe.

According to another aspect of the present invention, an apparatus for making a plastic pipe includes an extruder terminating in production direction in an adjustable pipe head for discharging a melt strand, a vacuum suction device receiving the melt strand from the pipe head for forming a pipe with a preliminary outer diameter, a sizing chamber, and a plurality of sizing sleeves having different inner diameter for selective placement in the sizing chamber for calibrating the pipe to have a desired outer diameter.

According to another feature of the present invention, a gripping device may be provided for transferring a selected one of the sizing sleeves to the sizing chamber, wherein the gripping device has a gripper arm provided with spaced-apart gripper stems for engagement in complementary receptacles of the selected one of the sizing sleeves to swing open the selected one of the sizing sleeves about a joint.

According to another feature of the present invention, each of the sizing sleeves may have sleeve segments moveable between an idle position and an operative position, with a locking mechanism provided for locking the sleeve segments in place, when assuming the operative position.

According to another feature of the present invention, the gripping device may include a lifting unit having a connection piece for connection to the gripper arm. The connection piece may be movably mounted to the lifting unit for traveling in a direction parallel to the production direction. The lifting unit may be constructed for movement in a direction transversely to a longitudinal axis of the extruder.

According to another feature of the present invention, a vacuum sizing tank may be disposed downstream of the sizing chamber for cooling and hardening the pipe, wherein the sizing chamber and the vacuum sizing tank are constructed for relative movement to each other for providing access to the sizing chamber to allow placement of the selected one of the sizing sleeves.

According to another feature of the present invention, the gripping device may have a support frame for carrying the lifting unit, wherein the connection piece is swingably mounted about an axis of the support frame.

According to another feature of the present invention, the gripper arm may be swingably mounted for rotation about its longitudinal axis.

According to another feature of the present invention, each of the sizing sleeves may be provided for realizing a particular pipe dimension and constructed for controlling a wall thickness of the pipe being calibrated.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of an extrusion plant according to the present invention;

FIG. 2 is a detailed view, on an enlarged scale, of a gripping device for transferring a selected sizing sleeve to the extrusion plant; and

FIG. 3 is a schematic illustration of the extrusion plant during exchange of a sizing sleeve.

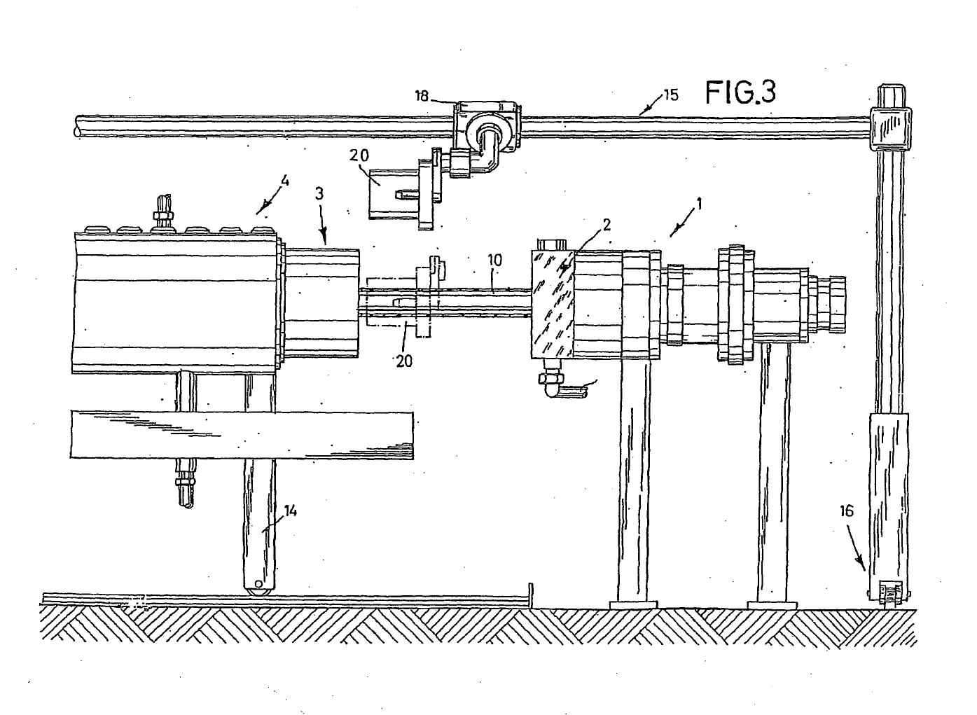

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

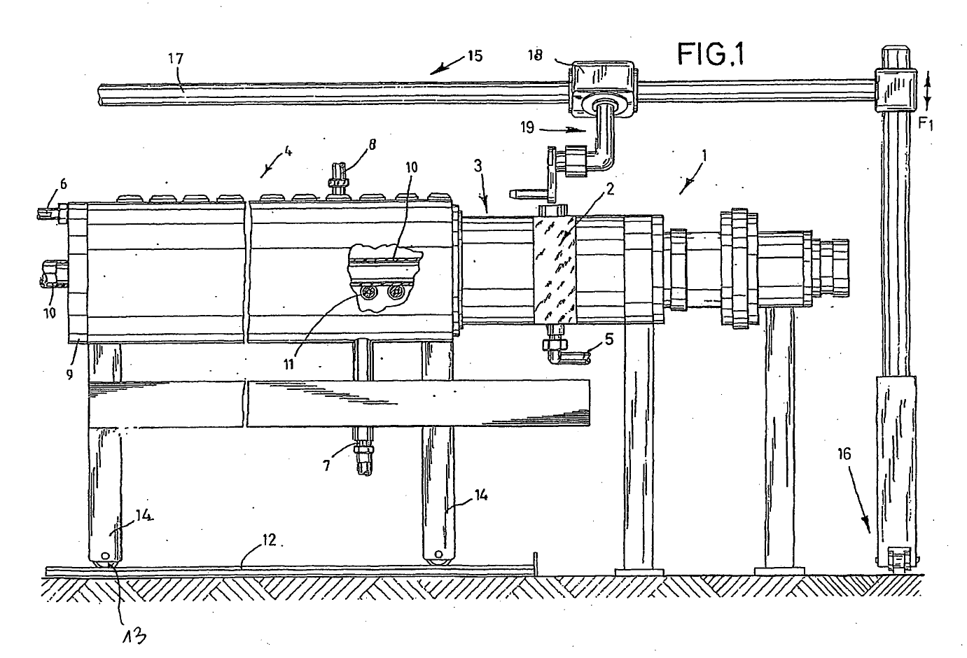

Turning now to the drawing, and in particular to FIG. 1, there is shown a schematic illustration of an extrusion plant according to the present invention, including a pipe head 1 which is connected to an end of an unillustrated extruder. The pipe head 1 is connected to a bell-shaped vacuum suction device 2 having a vacuum port 5 for connection to a vacuum source. Disposed in the vacuum port 5 are unillustrated measuring instruments for setting the vacuum in the suction device 2 in dependence on a desired pipe diameter. Thus, the tubular melt strand exiting the pipe head 1 is shaped to a preliminary outer diameter, i.e. expanded, and undergoes already in the vacuum suction device 2 a pre-cooling. The vacuum suction device 2 in combination with the pipe head 1 results in a precise formation of the pipe wall thickness, whereby the pipe wall thickness can be varied in dependence on the desired outer diameter.

The vacuum sizing device 2 is followed by a sizing chamber 3 by which the outer diameter of the melt strand, i.e. the previously shaped and partly cooled down and hardened pipe, is precisely calibrated.

A vacuum sizing tank 4 follows the sizing chamber 3 in the production line for cooling and hardening the plastic pipe by subjecting the advancing melt strand to spray water. The vacuum sizing tank 4 is provided with a water feed port 6 and a water drain port 7. Further connected to the vacuum sizing tank 4 is a vacuum connection 8. As shown by the area of the vacuum sizing tank 4 that has been broken away to gain a view of the interior thereof, a pipe 10 is advanced through the vacuum sizing tank 4 by support rollers 11, also called calibrating rollers, which can be adjusted to the desired outer diameter of the pipe 10. The surface of the pipe 10 is fairly hard, when leaving the vacuum sizing tank 4 via a vacuum sealing member 9, whereby the vacuum sealing member 9 is so constructed as to spontaneously adjust to the pipe diameter or is adjusted in dependence on the pipe dimensions. Form rollers may be disposed in the vacuum sealing member 9 and may be operated hydraulically or by mechanical springs, whereby water is injected for lubrication and sealing, as the pipe 10 passes by.

As further shown in FIG. 1 by way of example, the vacuum sizing tank 4 and the sizing chamber 3 may jointly travel on a track 12 via uprights 14 which are supported on rollers 13. In this way, the production line may, optionally, be interrupted by separating the vacuum sizing tank 4 and the sizing chamber 3 from the vacuum suction device 2 and pipe head 1 for a purpose to be described hereinafter.

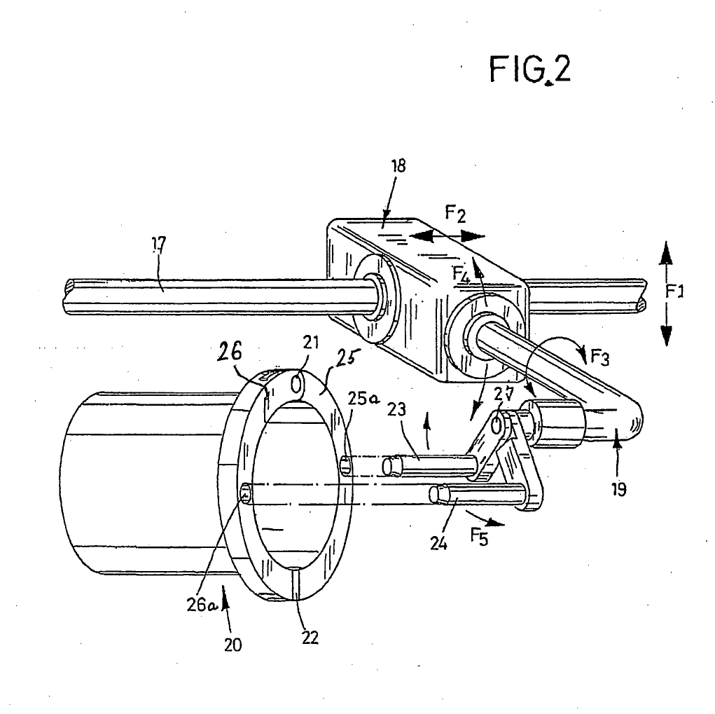

A lifting device, generally designated by reference numeral 15, is movably supported via roller-propped supports 16 for movement above and to the side of the extrusion line. The lifting device 15 includes a support frame 17 for attachment of a connection piece 18 which is provided with a gripper arm 19 which forms part of a gripping device and is constructed for replacing exchangeable sizing sleeves 20, shown schematically in FIG. 2. The support frame 17 is movable up and down in a direction of double arrow F₁.

The gripping device is shown in greater detail in FIG. 2, depicting the support frame 17 together with the connection piece 18 and the gripper arm 19. The gripper arm 19 has a free end which supports spaced-apart gripper stems 23, 24 which are movable about a joint 27.

FIG. 2 shows also an example of one sizing sleeve 20 out of a plurality of sizing sleeves which vary in their inner diameter. The sizing sleeve 20 includes two segments 25, 26 which are connected to one another via a joint 21 so as to be able to swing out for attachment in surrounding relationship to a pipe 10. Disposed in opposition to the joint 21 is a locking mechanism 22, which locks the segments 25, 26 in place, when the sizing sleeve 20 is wrapped around the pipe 10 and then inserted in the sizing chamber 3. There are many ways to implement such a locking mechanism. For example, the locking mechanism may include a centering ring which is integrated in the sizing chamber 3 for engagement in the sizing sleeve 20, when the sizing sleeve 20 is placed in the sizing chamber 3. Of course more than one such centering ring may be provided, and the centering ring may also be comprised of several segments. The locking mechanism 22 may also be configured as a locking pin which is received in the sizing chamber 3 for automatic engagement in the sizing sleeve 20. As an alternative, the locking pin 22 may also engage the sizing sleeve 20 before the sizing sleeve 20 is placed in the sizing chamber 3.

The gripping device operates as follows: A sizing sleeve 20 is selected from the array of sizing sleeves for attachment to the pipe 10 passing through the production line and exiting the vacuum suction device 2. The gripper stems 23, 24 of the gripper arm 19 engage in pockets 25a, 26a of the segments 25, 26 of the selected sizing sleeve 20 through suitable adjustments and then open the sizing sleeve 20 by moving in a direction of arrow F₅ so that the segments 25, 26 swing outwards about the joint 21. Of course, the locking mechanism 22 has been released beforehand. The sizing sleeve 20 is subsequently placed about the pipe 10, and the gripper stems 23, 24 swing the segments 25, 26 inwards to close the sizing sleeve 20 and wrap the sizing sleeve 20 about the pipe 10. The locking mechanism 22 locks the segments 25, 26 in place, and the sizing sleeve 20 is now in operative position. While the sizing sleeve 20 is placed over the pipe 10, the production line continues although at reduced speed, so-called creep speed, so that a shut down of the production is not required.

A specific construction of a possible configuration of a sizing sleeve that can be operatively and functionally incorporated into the production line is fully described in published International PCT Application WO 96/36475, the entire specification and drawings of which are expressly incorporated herein by reference. Slight adjustment of the individual segments that form the sizing sleeve are possible to attain a smooth pipe inner surface in the sizing sleeve and the inner radius of the pipe inner surface of the sizing sleeve 20 can be adjusted to slight wall thicknesses.

FIG. 2 also shows the various motions that the gripping device is capable of implementing. The arrow F₁ indicates the possible movement of the support frame 17, arrow F₂ indicates the movement of the connection piece 18 along the support frame 17, arrow F₃ indicates the possible pivot movement of the gripper arm 19 about its longitudinal axis, arrow F₄ indicates the possible pivot movement of the connection piece 18 about the support frame 17. As a result, all positions can be realized that are necessary to remove a sizing sleeve 20 from the sizing chamber 3 for transfer to a storage place, and vice versa, i.e. withdrawal of a new sizing sleeve 20 from the storage place for attachment to the pipe 10 and subsequent placement into the sizing chamber 3.

As an alternative to the afore-described process, it is also possible to secure a sizing sleeve 20 to the pipe 10 by cutting the pipe 10 in an area between the vacuum suction device 2 and the sizing chamber 3 and then simply placing the sizing sleeve 20 into the sizing chamber 3. This procedure requires, however a shutdown of the extrusion line and a displacement of the sizing chamber 3 in relation to the vacuum suction device 2 along the track 12 in order to gain access to the sizing chamber 3 and to allow the gripper arm 19 to place the selected sizing sleeve 20 inside the sizing chamber 3. Suitably, cooling devices may be provided to cool the exposed pipe 10 in the area between the vacuum suction device 2 and the sizing chamber 3 and thus to prevent a sagging of the pipe 10.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A method of making a plastic pipe; comprising the steps of:
producing a melt strand in an extruder and pushing the melt strand through a pipe head;
advancing the melt strand through a vacuum suction device for providing a pipe with a preliminary outer diameter;
placing a selected sizing sleeve of a plurality of different sizing sleeves in a sizing chamber for calibrating the outer diameter of the pipe in the sizing chamber to a desired dimension; and
cooling and hardening the pipe in a sizing tank.

2. The method of claim 1, wherein the placing step includes the steps of halting an advance of the pipe, and severing the pipe to provide access to the sizing chamber for placement of the selected one of the sizing sleeves.

3. The method of claim 1, wherein the placing step includes the steps of advancing the pipe at creep speed, attaching the selected one of the sizing sleeves in surrounding relationship to the pipe, and advancing the pipe through the sizing chamber.

4. The method of claim 3, wherein the attaching step includes the step of connecting single segments of the selected one of the sizing sleeves to the pipe until the pipe is embraced by the sizing sleeve.

5. A method of making a plastic pipe; comprising the steps of:
continuously advancing an extruded tubular melt strand through a production line;
selecting a sizing sleeve from a plurality of sizing sleeves;
swinging segments of the selected one of the sizing sleeves outwards to allow attachment of the sizing sleeve to the melt strand before placement in a sizing chamber;
swinging the segments inwards to fully embrace the melt strand;
locking the segments of the sizing sleeve; and
transferring the sizing sleeve into the sizing chamber for calibrating an outer diameter of the melt strand to provide a pipe with a desired dimension.

6. The method of claim 5, wherein the advancing step is realized at reduced speed.

7. A method of making a plastic pipe; comprising the steps of:
advancing an extruded tubular melt strand through a production line;
selecting a sizing sleeve from a plurality of sizing sleeves;
stopping the production line while cutting the melt strand to allow attachment of the selected one of the sizing sleeves to the melt strand before placement in a sizing chamber; and
transferring the sizing sleeve into the sizing chamber for calibrating an outer diameter of the melt strand to provide a pipe with a desired dimension.

8. Apparatus for making a plastic pipe, comprising:
an extruder terminating in production direction in an adjustable pipe head for discharging a melt strand;
a vacuum suction device receiving the melt strand from the pipe head and controllable to form a pipe with a preliminary outer diameter;
a sizing chamber; and
a plurality of sizing sleeves having different inner diameter for selective placement in the sizing chamber for calibrating the pipe to have a desired outer diameter.

9. The apparatus of claim 8, further comprising a gripping device for transferring a selected one of the sizing sleeves to the sizing chamber, said gripping device having a gripper arm provided with spaced-apart gripper stems for engagement in complementary pockets of the selected one of the sizing sleeves to swing open the selected one of the sizing sleeves about a joint.

10. The apparatus of claim 8, wherein each of the sizing sleeves is comprised of sleeve segments moveable between an idle position and an operative position, and further comprising a locking mechanism for locking the sleeve segments in place, when assuming the operative position.

11. The apparatus of claim 9, wherein the gripping device includes a lifting unit having a connection piece for connection to the gripper arm.

12. The apparatus of claim 11, wherein the connection piece is movably mounted to the lifting unit for traveling in a direction parallel to the production direction.

13. The apparatus of claim 11, wherein the lifting unit is constructed for movement in a direction transversely to a longitudinal axis of the extruder.

14. The apparatus of claim 8, further comprising a vacuum sizing tank disposed downstream of the sizing chamber for cooling and hardening the pipe, wherein the sizing chamber and the vacuum sizing tank are constructed for relative movement to each other for providing access to the sizing chamber to allow placement of the selected one of the sizing sleeves.

15. The apparatus of claim 11, wherein the gripping device has a support frame for carrying the lifting unit, said connection piece being swingably mounted about an axis of the support frame.

16. The apparatus of claim 9, wherein the gripper arm is swingably mounted for rotation about its longitudinal axis.

17. The apparatus of claim 8, wherein each of the sizing sleeves is provided for realizing a particular pipe dimension and constructed for controlling a wall thickness of the pipe being calibrated.

18. The apparatus of claim 8, wherein each of the sizing sleeves is comprised of a plurality of segments which are connectable to one another.
